(19) United States
(12) Patent Application Publication
(10) Pub. No.: US 2014/0180709 A1
(43) Pub. Date: Jun. 26, 2014

(54) METHODS FOR DRUG DELIVERY

(71) Applicant: Kindred Biosciences, Inc., San Francisco, CA (US)

(72) Inventor: Richard Chin, San Francisco, CA (US)

(73) Assignee: Kindred Biosciences, Inc., San Francisco, CA (US)

(21) Appl. No.: 14/135,261

(22) Filed: Dec. 19, 2013

Related U.S. Application Data
(60) Provisional application No. 61/745,689, filed on Dec. 24, 2012.

(51) Int. Cl. G06F 19/00

(52) U.S. Cl. CPC G06F 19/3456
USPC 705/2

(57) ABSTRACT

Methods for delivering a drug to an animal while preventing or reducing the risk of exposure of a human to the drug are provided in which the involved prescribers, pharmacies, veterinarians, and/or owners are registered in one or more computer databases. Embodiments are also provided in which registered owners or other registrants receive counseling information concerning the risks attendant to human exposure to the drug. Embodiments are also provided in which a global positioning system, mobile device, Internet, radio frequency identification chips, and/or other electronic devices and systems are utilized.

### RELATED APPLICATION

This application claims priority to U.S. Provisional Patent Application Ser. No. 61/745,689, filed Dec. 24, 2012 and titled METHODS FOR DRUG DELIVERY, which is incorporated herein by reference in its entirety.

### FIELD OF THE INVENTION

The present invention relates to methods for delivering a drug to a veterinarian or other animal care provider for administration to an animal. More particularly, the present invention relates to novel methods for delivering a drug to animal health care providers in a manner that reduces or eliminates the likelihood that a human will be administered the drug.

### BACKGROUND OF THE INVENTION

Many drugs that are toxic or otherwise hazardous to humans are less hazardous or non-hazardous to animals. However, such drugs are often withdrawn from or not available on the market because of the danger to humans. As a result, the drugs become unavailable for use in animals, because no method exists for insuring that drugs made available for animals that may be hazardous to humans do not get administered to humans. For example, cisapride causes fatal cardiac arrhythmias in humans but generally not in dogs. As another example, metamizole causes fatal agranulocytosis in humans but generally not in dogs. Zomepirac causes fatal anaphylaxis in human but not in cats, which lack the enzyme involved in the anaphylactic reaction.

In addition, many drugs that are hazardous to humans and to animals, such as thalidomide, are made available under a restricted distribution system designed for humans (see U.S. Pat. Nos. 6,045,501; 6,315,720; 6,561,976; 6,561,977; 6,767,326; 6,908,342; and 7,874,984, each of which is incorporated herein by reference). Such systems are not designed for animal owners and cannot accommodate them. As a result, valuable drugs for animals are available for animal use.

In addition, many drugs that are effective in animals are effective in humans. However, the price for animal drugs may be lower than the price for an equivalent human drug. As result, manufacturers may lose potential revenue when lower priced animal drugs are used by humans.

Thus, there remains a need for a drug delivery system that would enable drugs to be delivered to animal health care providers with minimal risk of the drugs being administered to humans. The present invention meets this need.

### SUMMARY OF THE INVENTION

The present invention is directed to methods for the delivery of a drug for use in animals to animal health care providers with reduced or no likelihood of administration of the drug to humans.

In a first aspect, there are provided methods for delivering a drug to animals in need of the drug while avoiding the administration of the drug to humans. In various embodiments, the drug is a drug that is hazardous to humans or is priced differently from the same drug when sold for use in humans or is prepared in unit dosage forms not approved for use in humans. In various embodiments, owners, prescribers, veterinarians, and/or other dispensers are registered in a human or machine-readable storage medium.

In a second aspect, the present invention provides electronic devices that are capable of storing information necessary for delivering hazardous drug to animals in need of the drug while avoiding or eliminating the risk of administration of the drug to humans.

In a third aspect, the present invention provides packaging that identifies packages or unit dose forms of the drug to permit tracking thereof to reduce the risk that the drug will be administered to a human.

### DETAILED DESCRIPTION OF THE INVENTION

As used herein, the term “Animal” means a non-human animal.

As used herein, the terms “Drug” or “medicine” means a pharmaceutical product, biological product, herbal product, or food containing a pharmaceutical product, biological product or herbal product that is intended for diagnosis, cure, mitigation, treatment, or prevention of disease or potential disease, or to affect the structure or function of the body.

As used herein, the term “Dispenser” refers to any individual who is capable of filling a prescription or giving drug to an animal or an owner of an animal, including, for example, pharmacists and veterinarians.

As used herein, the term “GPS” refers to a positioning system such as a global positioning system, a Wi-Fi based positioning system, or a system that can assess the position of a device or other object to which a device incorporating the system is attached.

As used herein, the term “Hazardous” means dangerous, toxic, associated with undesired or unacceptable side effects, contraindicated, suspected of being dangerous, suspected of being toxic, or suspected of causing undesired or unacceptable side effects.

As used herein, the term “Human” means a human being and includes a fetus.

As used herein, the term “Living being” means human or non-human animal.

As used herein, the term “NFC” refers to near field communication.

As used herein, the term “Owner” means the owner of an animal or a custodian of an animal who has authority to treat the animal with a drug.

As used herein, the term “Prescriber” refers to any individual who is capable of prescribing drugs for animals, including, for example a veterinarian.

As used herein, the term “Registering” means storing information or algorithm (whether name, identification number, radio frequency identification, phone number, electronic serial identification of a mobile phone, or other information).

As used herein, the term “RFID” refers to radio frequency identification or a similar system.

As used herein, the term “SMS” refers to short message system or a similar system.

The drug delivery methods described herein involve the registration of a prescriber authorized to prescribe a drug in a machine-readable medium. The prescriber may be, for example, a veterinarian. Typically, the machine is a computer, cell phone, mobile device, or other electronic or photonic computing device. Once registered in the medium, a prescriber may be or is eligible to prescribe the drug. To be registered in the medium, the prescriber may be, in some embodiments, required to become educated in the requirements of the system, to become educated in the potential hazards of the drug, or to fulfill other requirements. The prescriber may be, in some embodiments, required to submit his or her registration information by letter, card, Internet, SMS, cellphone, microblog, fax, telephone, or by other methods. The registration information may include, in various embodiments, the registrant's name, professional license information, proof that requirements were met, address, phone number, email address, and/or other information. The registration information may be, in some embodiments, combined or referenced against one or more databases to verify the legitimacy of the information and the prior history of the prescriber in the same or similar registration programs. An algorithm may be utilized in some embodiments to accept or reject the registration. Based on information that becomes available later, the registration may be revoked or a rejected registration may be accepted one or more times.

The drug delivery methods described herein typically involve the registration in a machine-readable medium of the dispensers authorized to dispense a drug. The machine-readable medium may be the same as or different from the medium used for registration of the prescriber. The dispenser may be the same or different from the prescriber, and may be a veterinarian, a pharmacist, pharmacy, or another party. Typically, the machine is a computer, cell phone, mobile device, or other electronic or photonic computing device. Once registered in the medium, the dispenser may be, in some embodiments, eligible to dispense the drug. To be registered in the medium, the dispenser may be, in some embodiments, required to become educated in the requirements of the system, to become educated in the potential hazards of the drug, or fulfill other requirements. The dispenser may be, in some embodiments, required to submit his or her registration information by letter, card, Internet, SMS, cellphone, microblog, fax, telephone, or by other methods. The registration information may include, in some embodiments, his or her name, professional license information, proof that requirements were met, address, phone number, email address, and/or other information. The registration information may be, in some embodiments, combined or referenced against one or more databases to verify the legitimacy of the information and the prior history of the dispenser in the same or similar registration programs. An algorithm may be utilized to accept or reject the registration. Based on information that becomes available later, the registration may be, in some embodiments, revoked or a rejected registration may be accepted one or more times.

The drug delivery methods described herein typically involve the registration in a machine-readable medium of the animal owner. The machine-readable medium may be, in some embodiments, the same as or different from the medium used for registration of the prescriber and/or the dispenser. Typically, the machine is a computer, cell phone, mobile device, or other electronic or photonic computing device. Once registered in the medium, the owner may be, in some embodiments, eligible to receive the drug. To be registered in the medium, the owner may be, in some embodiments, required to become educated in the requirements of the system, to become educated in the potential hazards of the drug, sign an informed consent form, sign an agreement not to give the drug to a human, or fulfill other requirements. The owner may be, in some embodiments, required to submit his or her registration information by letter, card, Internet, SMS, cellphone, microblog, fax, telephone, or by other methods. The submission may be directly to the manufacturer of the drug or indirectly through the veterinarian or another third party. The registration information may include, in some embodiments, his or her name, proof that requirements were met, address, phone number, email address, and/or other information. The registration information may be, in some embodiments, combined or referenced against one or more databases to verify the legitimacy of the information and the prior history of the owner in the same or similar registration programs. An algorithm may be utilized in some embodiments to accept or reject the registration. Based on information that becomes available later, the registration may be, in some embodiments, revoked or a rejected registration may be accepted one or more times.

The drug delivery methods described herein typically involve the registration of the animal in a machine-readable medium. The machine-readable medium may be, in some embodiments, the same as or different from the medium used for registration of the owner, the prescriber, and/or the dispenser. Typically, the machine is a computer, cell phone, mobile device, or other electronic or photonic computing device. Once registered in the medium, the animal may be, in some embodiments, eligible to receive the drug. To be registered in the medium, the animal may be, in some embodiments, required to have an RFID microchip implanted or read, or have other identifying information recorded. The animal information may be, in some embodiments, submitted by letter, card, Internet, SMS, cellphone, microblog, fax, telephone, or by other methods. The submission may be, in some embodiments, directly to the manufacturer of the drug or indirectly through the veterinarian or another third party. The registration information may, in some embodiments, include the animal's name; RFID information; proof that requirements were met; owner's name, address, phone number, email address; and/or other information. The registration information may be, in some embodiments, combined or referenced against one or more databases to verify the legitimacy of the information and the prior history of the animal in the same or similar registration programs. An algorithm may be utilized, in some embodiments, to accept or reject the registration. Based on information that becomes available later, the registration may be, in some embodiments, revoked or a rejected registration may be accepted one or more times.

In accordance with the methods of the present invention, the delivery of the drug to the owner may involve one or more of the following steps. As a prelude to prescribing and dispensing the drug to the owner, the prescriber and the dispenser are registered in one or more appropriate machine-readable storage media, as described above. If the prescriber is not registered in the machine-readable storage medium, the prescriber will be ineligible to prescribe the drug. Similarly, if the dispenser is not registered in the machine-readable storage medium, the dispenser will be ineligible to dispense the drug.

In the course of an examination of an animal, the prescriber may determine that the animal's condition would be improved by the administration of a drug such as, for example, a drug hazardous to humans such as zomepirac, cisapride, metamizole, or thalidomide. Prior to prescribing the drug, the prescriber preferably counsels the owner, for example, on the various risks and benefits associated with the drug to the animal and to humans. For example, the prescriber may discuss the risk of anaphylaxis associated with zomepirac in humans. The prescriber may provide owners with literature information, for example, in the form of the aforesaid product information, educational brochures, owner instruction videos, and the like, warning the owner of the effects of the drug in humans and animals.

In addition to receiving counseling on the drug being prescribed, including counseling, for example, on birth control or other precautions to be taken with the animal, and prior to receiving a prescription for the drug, the methods of the present invention can involve requiring the owner to fill out an informed consent form or an agreement signed by the prescriber, as well as the owner. By filling out and signing an informed consent form, the owner acknowledges that he/she understands the risks associated with the drug and/or agrees not to administer the drug to a human.

After the above steps, the owner receives the drug. The dispensation of the drug can be recorded in human-readable or machine-readable medium in accordance with the invention.

In some embodiments, the registration of the prescriber, dispenser, owner, and/or the animal is performed by using Facebook, Google checkout, Amazon checkout, NFC, GPS, or other similar identification or location systems. For example, the registration of the prescriber may be performed based on the GPS location of the transaction that matches the transaction to the address of the veterinary hospital or clinic.

After verifying that the owner has been registered as above, the prescriber may prescribe the drug to the owner, or the prescriber/dispenser may dispense the drug to the owner. In various embodiments of the present invention, the amount of the drug that is prescribed or dispensed to the owner is for a limited amount, which may be for no more than about 30 days or some other period of time.

If the prescriber is not also the dispenser, then, in some embodiments, to have the prescription filled, the owner presents the prescription and the informed consent form to a pharmacy that has been registered, as discussed above. It is contemplated that the owner may bring the prescription to an unregistered pharmacy. If so, the pharmacy may take steps in accordance with the invention to become registered, for example, by contacting the manufacturer of the drug. Once registration of the pharmacy is completed, the distribution procedure described herein may resume, per the discussion below.

The dispenser will verify that the owner and/or prescriber is registered prior to the dispensation of the drug. In some embodiments, the dispenser receives authorization for the dispensation in addition to the said verification.

If the owner is not registered, then the dispenser may register the owner.

The drug and/or the drug package can, in some embodiments, have a unique identifier. The identifier may be a number, alphanumeric code, RFID, NFC, or a similar identifier. Both the unit dose forms of the drug itself (individual pills) and the packaging may have unique identifiers. The packaging may incorporate a GPS tracking system. The drug is in various embodiments supplied to the pharmacy (as well as the owner) in packaging, such as individual blister packs, which includes warnings regarding the risks associated with the drug.

At approximately the time of each dispensation, or shortly after the dispensation, the dispenser will register the dispensation. In some embodiments, the dispenser scans the dispensed drug or drug package, either with a bar code reader or another device, and enters one or more of the name of the owner, date, name of the animal, and other pertinent information into a website that would transmit the information to the drug manufacturer or distributor, or an agent of the drug manufacturer or distributor. In various embodiments, the dispenser utilizes a mobile device to scan the drug package's bar code or RFID, scan the owner's phone's NFC, scan the dog's RFID, and transmits the information along with the GPS coordinate of the device, date, and time to the manufacturer. An app or software that can perform such a task is in various embodiments made available for a wide array of mobile or non-mobile devices.

As noted above, the drug can be dispensed to the owner in a limited amount, with a prescription amount of no more than about 30 days being typical, and optionally with no refills being permitted. Thus, for the owner to obtain an additional prescription, it is generally necessary for the owner to have a follow-up visit with the prescriber. Such a follow-up visit can take place at least each time the owner requires a renewal of the prescription, and possibly more often if the owner requires, for example, additional counseling.

In various embodiments, the prescriber will also receive reminders, for example, via mail, fax, email, SMS message or telephone call from the manufacturer, distributor, or other group or body providing oversight on drug distribution, that the prescriber has prescribed a hazardous drug to owners which should not be used for humans. In various embodiments, the prescriber will also receive reports, for example, via mail, fax, email, SMS message or telephone call from the manufacturer, reporting dispensation of the drug.

In various embodiments, the owner will also receive reminders, for example, via mail, fax, email, SMS message or telephone call from the manufacturer, distributor or other group or body providing oversight on drug distribution, that the prescriber has prescribed a hazardous drug to owners which should not be used for humans. In various embodiments, the owners are queried about the safety, tolerability, palatability, owner satisfaction and/or efficacy of the drug; and about the health of the animal. Such information can be used for commercial or research purposes. For example, it may be used to determine what kind of animals responds the best to the drug. Alternatively, it may be used to identify owners who are the most likely to divert the drug.

The registration into one or more machine-readable storage media of the prescriber, pharmacy and owner, according to the methods described herein, provide a means to monitor and authorize distribution of the drug. Thus, the machine-readable storage media provides a way to deny access, dispensation, or prescriptions of the drug. As discussed above, prescribers who are not registered in a machine-readable storage medium generally may not prescribe the drug, and pharmacies that are not registered generally may not dispense the drug. Similarly, the drugs generally may not be dispensed to owners who are not registered in a machine-readable storage medium. Also, if some of the drug is determined to have been diverted to human or other uses, the source of diversion can be identified and the registration of the responsible parties can be revoked. In an alternate embodiment, the information is recorded in a human-readable medium, such as paper.

In any of the aspects and embodiments of the invention, the drug may be selected from the group consisting of diethylstilbestrol (DES), cisapride, metamizole, thalidomide, mitotane, seldane, and zomepirac

Various modifications of the invention, in addition to those described herein, will be apparent to those skilled in the art from the foregoing description. Such modifications fall within the scope of the appended claims.

### Example 1

A veterinarian receives registration material for cisapride from the manufacturer. He studies the educational material, and takes an online test, which includes information that cisapride can cause lethal cardiac arrhythmia in humans but not in dogs. He passes the test, and enters his name, licensure information, address, email, and other contact information. He receives drug packages that have RFID unique identifier.

The veterinarian identifies an animal that would benefit from the drug. He counsels the owner. The owner read the educational information and signs an online consent form. The veterinarian verifies that the owner has been registered by using an app on his phone to query the manufacturer's database.

The veterinarian, using an app on his cellphone, scans the RFID from the drug package, RFID in the dog, and the NFC chip in the cellphone of the owner. The cellphone transmits the information to the manufacturer.

### Example 2

A veterinarian receives registration material on metamizole from the manufacturer. He studies the educational material, and takes an online test which includes information that metamizole can cause fatal agranulocytosis in humans but not in dogs. He passes the test, and enters his name, licensure information, address, email, and other contact information. He receives drug packages that have RFID unique identifier.

The veterinarian identifies an animal that would benefit from the drug. He counsels the owner. The owner read the educational information and signs an online consent form. The veterinarian verifies that the owner has been registered by using an app on his phone to query the manufacturer's database.

The veterinarian, using an app on his cellphone, scans the RFID from the drug package, RFID in the dog, and the NFC chip in the cellphone of the owner. The cellphone transmits the information to the manufacturer.

1. A method for delivering a drug to an animal health care provider with reduced likelihood of administration of said drug to a human being, comprising:
a. registering in a machine or human-readable storage medium prescribers who are qualified to prescribe said drug;
b. registering owners of said animals in said medium; and
c. verifying a and b before dispensation of the drug.

2. The method of claim 1 further comprising registering in said medium dispensers authorized to dispense the said drug.

3. The method of claim 1 further comprising registering said animals in said medium.

4. The method of claim 1 further comprising providing to the owners counseling information concerning the risks attendant to exposure to said drug.

5. The method of claim 1 further comprising registering the dispensation of the drug.

6. The method of claim 2 wherein refilling of said prescriptions is authorizable only in response to information contained on said machine-readable storage medium.

7. The method of claim 1 wherein registration or authorization or both are performed while utilizing the internet, cellular telephone system, cellular telephone equipment, equipment capable of making a telephone call, equipment capable of transmitting data electronically, or other electronic media.

8. The method of claim 1 wherein registration or authorization or both are performed while utilizing information from a global positioning system or other location-based information system.

9. The method of claim 1 wherein registration or authorization or both are performed while utilizing information from a radio frequency identification, mobile phone based identification system, or other electronic identification system

10. The method of claim 1 further comprising:
d. registering said animals in said medium;
e. providing to the owners, counseling information concerning the risks attendant to exposure to said drug; and
f. registering the dispensation of the drug.

11. A method for delivering a drug to an animal health care provider while reducing the risk that said drug will be administered to a human being comprising:
a. registering in a machine or human-readable storage medium prescribers who are qualified to prescribe said drug;
b. registering the owner in said medium; and
c. authorizing dispensation of the drug,
wherein registration or authorization or both are performed while utilizing information from a radio frequency identification, mobile phone based identification system, or other electronic identification system.

12. The method of claim 11 wherein registration or authorization or both are performed while utilizing information from a global positioning system or other location based information system.

13. The method of claim 1 wherein the drug is diethylstilbestrol (DES), cisapride, metamizole, thalidomide, mitotane, seldane, or zomepirac.

14. A machine-readable medium containing registration information of a prescriber, dispenser, owner, and/or an animal, useful for the purpose of enabling the delivery of a drug to an animal health care provider while reducing the likelihood that the drug will be administered to a human being

15. Drug packaging with a unique identifier that enables the delivery of a drug to an animal in need of the drug while reducing or eliminating the likelihood of delivery of said drug to a human being

16. The drug packaging of claim 15 wherein the unique identifier is an electronic tag such as RFID or NFC.
